(19) United States
(12) Patent Application Publication
(10) Pub. No.: US 2009/0078321 A1
(43) Pub. Date: Mar. 26, 2009

(54) Gas pressure regulator having a regulator cap for a bayonet engagement with the regulator body

(75) Inventors: Glen Arnott, New Braunfels, TX (US); Henry Pearson, New Braunfels, TX (US)

Correspondence Address: JACKSON WALKER, L.L.P., 112 E. PECAN, SUITE 2400, SAN ANTONIO, TX, 78205, US

(73) Assignee: Daniel A. Holt, d/b/a REHVAC Manufacturing Ltd.

(21) Appl. No.: 12/217,027

(22) Filed: Jul. 1, 2008

Related U.S. Application Data
(60) Provisional application No. 60/994,621, filed on Sep. 20, 2007.

(51) Int. Cl. F16K 31/00

(52) U.S. Cl. 137/14; 124/74; 137/505.47; 137/315.04

(57) ABSTRACT

A gas pressure regulator comprising a housing. The housing includes a regulator cap and a regulator body. The regulator cap and the regulator body engage one another through the use of bayonets on one of the regulator cap or the regulator body and pockets on the other of the cap or body. The regulator housing includes a piston having a piston stem in a piston head. The piston stem has a channel and a seat seal on a removed end thereof, the channel for carrying gas to the piston head. The piston head also engages a piston spring. The regulator housing also includes an adjustable seat for receiving a high pressure compressed gas at one end and providing it to the piston stem at a second end. The adjustable seat is adjustable, such that when it is adjusted away from the piston stem, higher cutoff pressure is required than when it is closer. A kit for assisting in adjusting the outlet pressure of the gas pressure regulator is provided, as is a clamp and tools for engaging and disengaging the regulator cap from the regulator body.

This utility patent application is based on, claims the benefit of and priority from, and incorporates herein by reference co-pending U.S. Provisional Patent Application Ser. No. 60/994,621, filed Sep. 20, 2007.

### FIELD OF THE INVENTION

Gas regulators, namely, a gas pressure regulator having a novel regulator cap for bayonet type engagement with a regulator body, kits for assembly and disassembly of a regulator, and systems for adjusting the output pressure of a gas regulator.

### BACKGROUND

Gas pressure regulators are used in many applications, including the paint ball industry to recharge gas pressure cylinders on the paint ball guns. The paint ball guns use a gas pressure cylinder as part of the gun to propel paint balls and a gas pressure regulator in conjunction with the cylinder to control delivery of a set output pressure. Assembly and disassembly of a gas pressure regulator with respect to the paint ball gun is often required and there are certain problems with respect to prior art regulator body cap connections, which may be overcome by at least some of the novel features of Applicants' invention as set forth herein.

### OBJECT OF THE INVENTION

It is an object of the invention to provide for an improved gas pressure regulator for use with high pressure gas requiring safe gas pressure regulation.

It is another object of the invention to provide a nose piece that is held in place with high spring pressure and a retaining ring along with a bayonet style locking mechanism that will prevent the nose piece from inadvertently coming off the regulator body.

It is yet another object of the invention to provide an internal safety device that will bleed off excessive pressure.

It is another object of the invention to provide a regulator with an optimized load spring allowing for maximum regulator responsiveness.

It is yet another object of the invention to provide for a single gas pressure regulator that can interchangeably use different piston springs for different output settings, for example, either a 3000 or 4500 psi spring.

It is yet another object of the invention to provide for a regulator with an adjustable seat that allows output pressure to be fine tuned as needed, easily and efficiently.

It is another object of the invention to provide a bayonet engagement means for a housing and cap of a gas pressure regulator and a kit that includes a tool for use in assembly, disassembly, and adjustment of the regulator.

It is another object of the invention to provide a gas pressure regulator with a replaceable brass nose piece or cap that will resist bending when inadvertently dropped.

It is yet another object of the invention to provide an internally adjustable gas pressure regulator for accurately adjusting the pressure in a regulated chamber thereof.

It is yet another object of the present invention to provide a gas pressure regulator in which all parts are replaceable.

### SUMMARY OF THE INVENTION

A gas pressure regulator comprising a housing. The housing includes a regulator cap and a regulator body. The regulator cap and the regulator body engage one another through the use of bayonets on one of the regulator cap or the regulator body and pockets on the other of the cap or body. The regulator housing includes a piston having a piston stem in a piston head. The piston stem has a channel and a seat seal on a removed end thereof, the channel for carrying gas to the piston head. The piston head also engages a piston spring. The regulator housing also includes an adjustable seat for receiving a high pressure compressed gas at one end and providing it to the piston stem at a second end. The adjustable seat is adjustable, such that when it is adjusted away from the piston stem, higher cutoff pressure is required than when it is closer. A kit for assisting in adjusting the outlet pressure of the gas pressure regulator is provided, as is a clamp and tools for engaging and disengaging the regulator cap from the regulator body.

A bayonet cap for slidably engaging a gas pressure regulator body, the bayonet cap having bayonets for engaging pockets in the body and walls to engage a piston and piston spring under compression with the bayonets seated in the pockets.

The gas pressure regulator set forth in the paragraph above, further including an adjustable seat for adjusting an output pressure.

The regulator set forth in the paragraph above further including a kit for assembly and disassembly of the regulator cap from the regulator body and a system including a method and tools for adjusting the output pressure of the novel bayonet cap gas pressure regulator.

The regulator set forth in the paragraph above, further comprising an adjustment system, including a setting tool and an adjustable head, the adjustment system for adjustably setting a regulated gas pressure output.

### BRIEF DESCRIPTION OF THE DRAWINGS

FIG. 1 is an elevational view of the workpiece, here, a paint ball gun, with which Applicant's novel bayonet cap pressure regulator is typically used.

FIG. 2 is a cross-sectional elevational side view of Applicants' novel regulator with the bayonet regulator cap incorporated therewith.

FIGS. 2A, 2B, 2C, 2D, and 2E illustrate elevational views of details of a novel tool set for use with Applicants' novel gas pressure regulator, namely, for selectively setting a regulated chamber gas pressure of the same.

FIG. 3 is a side elevational view of Applicants' novel gas pressure regulator illustrating the manner in which it cooperates with a clamp 50 in order to remove the regulator cap 12 from regulator body 14.

FIG. 4 is a partial side elevational view, exploded, showing the pressure regulator piston 16, piston load spring 18, and outlet valve piston 28.

FIGS. 5A, 5B, 5C, and 5D are various elevational and sectional views of the regulator cap.

FIGS. 6A, 6B, 6C, 6D, and 6E are various elevational and sectional views of the regulator body.

FIG. 6F illustrates a cross-sectional elevational view of the gas pressure regulator housing with the cap partially inserted into the regulator body illustrating the manner in which walls of the cap strike the piston head and spring before the bayonets of the cap have cleared the pockets, thus requiring the kit for compressing the body and the cap further before rotation and engagement of the cap bayonet to the body pockets.

FIG. 7 is an exploded view of Applicants' gas pressure regulator.

FIGS. 8A, 8B, and 8C illustrate a novel kit for use in assembly and disassembly of Applicants' novel gas pressure regulator.

FIG. 9 illustrates a cross-sectional view of an alternate preferred embodiment of Applicants' novel gas pressure regulator for in-line control of a gas pressure between an upstream and downstream line thereof.

FIG. 10 is an elevational view of a J-shaped pocket.

### DETAILED DESCRIPTION OF THE PREFERRED EMBODIMENT

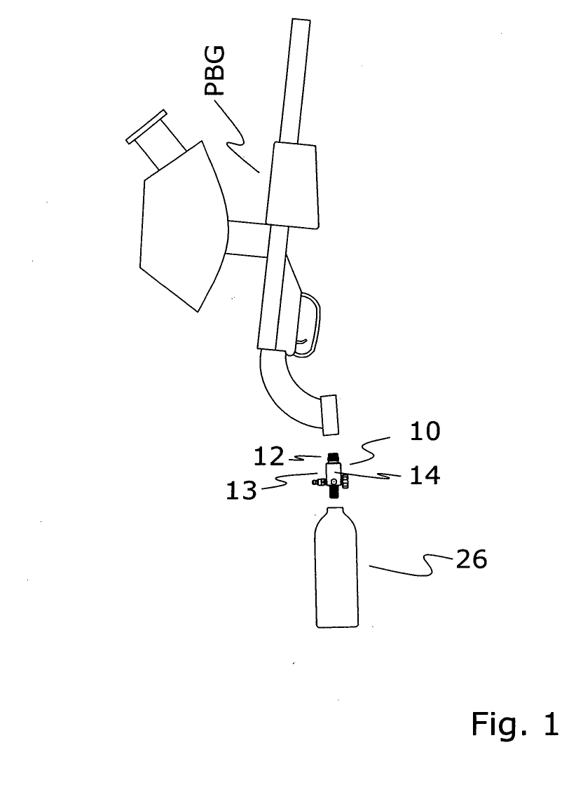

Turning to FIG. 1, it is seen that Applicants' novel pressure regulator 10 is typically used with a paint ball gun PBG, but may be suitable for many other gas regulating applications. A paint ball gun has a paint ball container and uses high pressure air supply cylinder 26 (gun cylinder), illustrated, along with gas pressure regulator 10 to provide regulated air pressure to propel a paint ball from the paint ball gun.

Periodically the high pressure air supply cylinder 26, which is attached to the gun, and may carry typically the 3,000 or 4,500 psi, needs to be replenished as from a compressor and/or high pressure supply tank. The pressure regulator 10 between the high pressure air supply cylinder 26 and the gun regulates the pressure providing the paint ball gun with typically about 850 psi output to propel the paint ball. Applicant provides, however, for adjustment of this output pressure as set forth below.

Typical prior art pressure regulators are threaded into the gun at one end (usually at the regulator cap) and threaded into a gun cylinder 26 at the other. Problems sometimes occur with the prior art regulator caps, which on one end thread into the paint ball gun body and the other end into the regulator body. It has been seen that they may come loose or unscrew when in use or inadvertently when removed from the paint ball gun.

Applicants provide a bayonet style locking cap for locking the regulator cap to the regulator body at one end, and provide the typical threads at the other end for the cap to thread into the paint ball gun body.

A number of prior art regulators, including those used in the paint ball industry, have a threaded connection between the paint ball connection (regulator) and the high end. When one attempts to unthread such a regulator from the paint ball gun, because of the pressure at the regulated gun, the torque required on the threads separating the regulator from the gun is quite high. Therefore, what may happen is the regulator may rotate not at the threaded end where it attaches to the gun, but the threaded end between the regulated and the high end. If that occurs, then the potential exists for explosive decompression when the body of the regulator is separated. In addition, since the threaded adjustment in the body of typical prior art regulators also adjusts the pressure set in the regulator chamber unthreading that coupling will change the adjustment setting. Therefore, with a bayonet style, which is not threadably adjusted, but instead is bayonet locked into a rotational position, inadvertent uncoupling is avoided. Moreover, the process of removal of a cap from the regulator body does not change the adjustment setting in the regulated chamber, because the special relationship of the components remain the same.

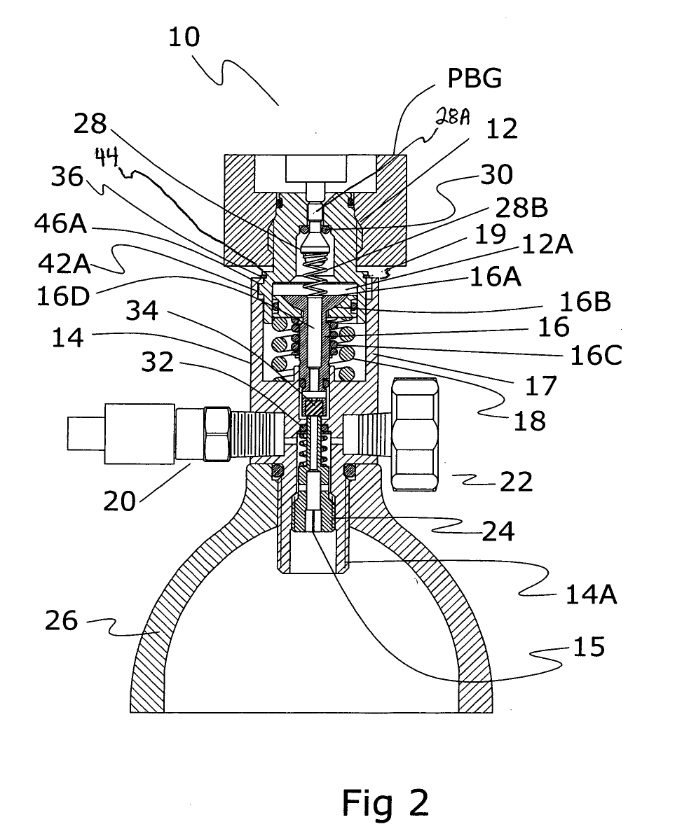

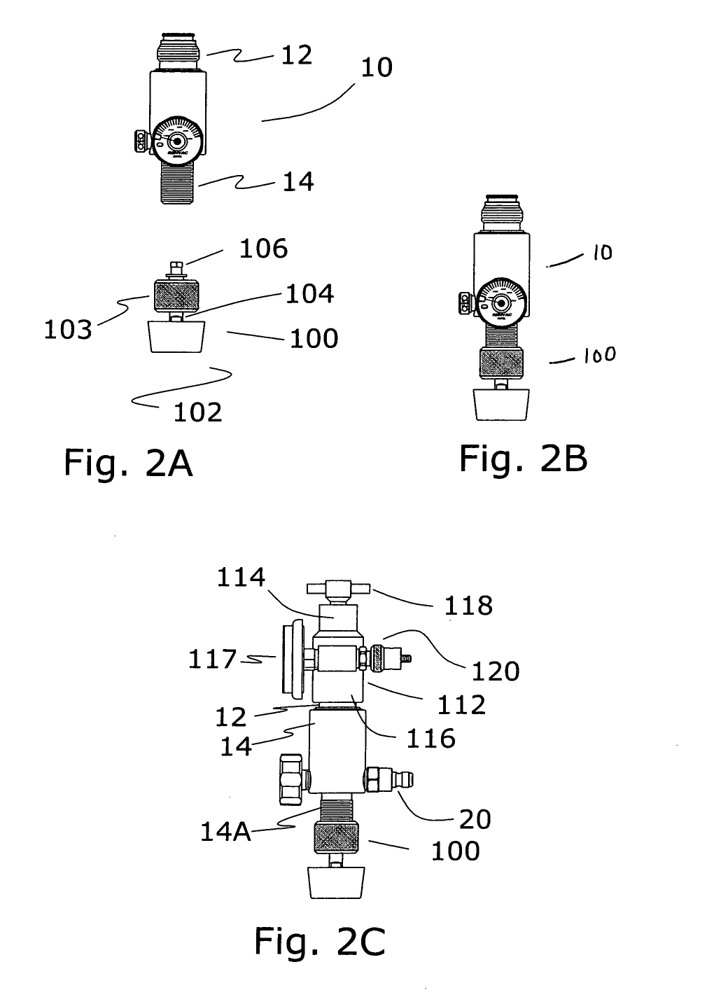

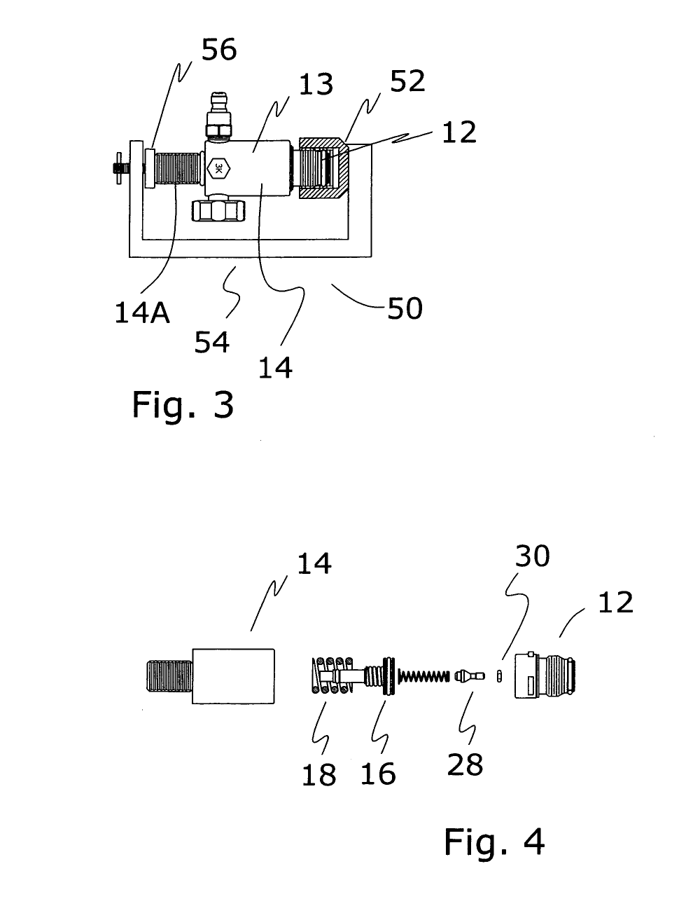

Turning now to FIGS. 2, 4, 5A-5D, 6A-6E, and 7, it is seen that Applicants provide a novel gas pressure regulator 10, having a regulator cap 12. The regulator cap 12 has a bayonet style connection to connect it to regulator body 14. The regulator cap 12 and body 14 together provide a regulator housing 13, the housing coupling and uncoupling as set forth herein. Details of the bayonet connection will be set forth below, after a few paragraphs describing the rest of the regulator.

Applicants' regulator includes a pressure regulating piston assembly 16 having load spring 18 designed to bias the piston assembly 16 closed. This structure is known in the art and may include a piston stem 16a, piston head 16b, and retainer spring 16c. While a unitary piston head and piston stem may be used, a preferred assembly 16 is shown, known as a bleed down piston assembly. This helps bleed an overpressurized regulated chamber 12a. Within the piston is a piston channel 16d for carrying gas therethrough. A fill port 20 is provided when it becomes necessary to recharge the paint ball gun air cylinder 26 or adjust the output pressure as set forth below. A pressure gauge 22 is typically provided for reflecting the pressure in the gun cylinder 26, so one may know when to refill.

An outlet valve piston 28 having a nose 28a is provided, seated against an outlet valve seal 30 by spring 28b, such that when the gas pressure regulator 10 is threaded onto the paint ball gun, outlet valve piston 28 is depressed (by contact of gun with nose 28a) and a regulated gas (for example, an adjustably set preselected pressure of 850 psi) may flow to the gun to propel the paint balls when the trigger is depressed.

An adjustable seat 24 may be threadably adjusted (as by a tool in hex opening or slot 15, for example) with respect to the regulator body 14 to selectively position pressure regulating piston seat port 24c, thus allowing the user to control the pressure exiting the upstream port of regulator cap 12 when it is engaged to the paint ball gun and when the outlet valve piston 28 is depressed.

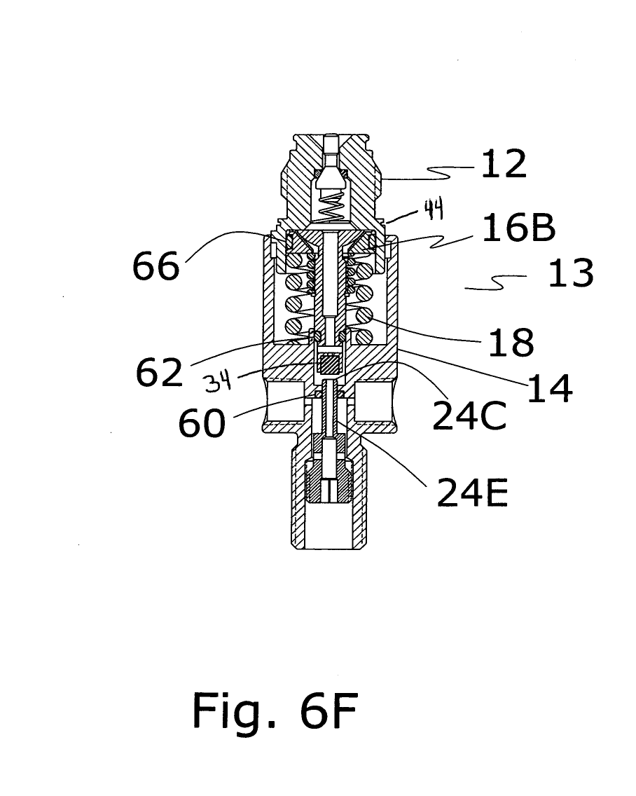

It may be seen with reference to FIGS. 2 and 7 that adjustable seat 24 may have a channel 24A therethrough with channel in fluid communication with side ports 24b. Seat port 24c is provided and a retainer spring 24D may be used in conjunction with a base 24g and an O-ring 24f. Retainer spring 24d may slide over neck 24e and, with base 24b (also dimensioned to slid over neck 24e), provide an effective seal with O-ring 24f. When threaded portion 24H is threaded into the removed end 14a of body 14 as seen in FIG. 2, O-ring 24f will provide a seal against and into the body such that side ports 24b may provide fluid communication with channel 24a to allow the filling of cylinder 26. Pressure gauge 22 may be read to determine the proper fill pressure (typically 3000 or 4500 pounds). Fill port 20 has check valve or other means to prevent loss of gas pressure.

With reference to FIG. 7, it is seen that the regulator body may include a safety valve 31. If the gun cylinder 26 is pressurized to 3000 psi, a safety valve with a frangible disc capable of blowing at 5000 psi would typically be provided. On the other hand, if the gun cylinder was designed to receive 4500 psi, the safety valve would typically be a 7000 psi safety valve. Further, it is seen that a pressure relief groove 33 may be dimensioned for receipt longitudinally across the threads comprising removed end 14a of the regulator body. This will allow gas to bleed out during the uncoupling of gun cylinder 26, rather than an explosive discharge that would occur otherwise.

It can be seen that adjustable seat 24 can be adjusted so as to selectively set the distance required for the movement of piston 16 to shut off flow through seat port 24c. As can be seen in FIG. 2, gas flows through seat port 24c through piston channel 16a into regulated chamber 12a. Thus, if one were to advance the position of adjustable seat 24, from the position set forth in FIG. 2 (thereby raising seat port 24c), one would decrease the compression required of spring 18 before piston seat seal 34 shuts off flow through seat port 24c. Moreover, it is seen that the use of outlet valve piston 28 and other structure allow this adjustment to be done with the regulator disengaged from paint ball gun PBG, as set forth in more detail below.

In another embodiment, opening 15 may have a hex shaped for receipt of a male hex head 106 as set forth below. FIGS. 2A-2E illustrate a manner of using an adjusting screw tool 100 in conjunction with an adjuster head 112 to adjustably set outlet pressure in outlet chamber 12a when Applicants' gas pressure regulator 10 is disengaged from the paint ball gun and the paint ball gun cylinder 26.

In FIGS. 2B and 2E, it is seen that adjusting screw tool 100 has an inside threaded rotatable member 103 that is rotatable about shaft 104. Hex head 106 may be snugly engaged into the opening or slot 15 of the adjusting tool and then the rotatable threaded member 103 may be threaded onto body 14 until the threaded member 103 bottoms against the regulator body threads of removed end 14a. At that point, handle 102 may be rotated, typically clockwise, to lightly bottom the adjustable seat 24 against piston seat seal (see FIG. 2). These steps are illustrated in FIGS. 2B and 2C.

In FIG. 2C and with further reference to FIG. 2D, it is seen that an adjuster head 112 may be provided that will threadably engage threaded portion of regulator cap 12 as seen in FIG. 2C. More specifically, with reference to FIGS. 2C and 2D, it is seen that adjuster head 112 may include a body 114 having a threaded portion 116 for threaded engagement with regulator cap 12 and further that adjuster head 112 may include a pressure gauge 117. A pin depressor 118 is threaded engaged to body 114 capable,of engaging and depressing nose 28A and thereby provide fluid communication between body 114, gauge 117, and regulated chamber 12a. That is to say, when depressor 118 is threaded in, after adjuster head 112 is tightly sealed against regulator cap 12, gauge 117 will read pressure in regulated chamber 12a. A bleed nut 120 is provided to bleed pressure from body 114. The gauge and bleed nut may engage body 114 directly or through a “T” fitting 119. (“T” fitting in FIG. 2D is rotated 90° from its normal position.)

Turning to FIG. 2C, it is seen that adjuster head 112 may be threadably engaged to regulated cap and pin depressor 118 may be turned to depress outlet valve 28. The bleed nut 120 should be in the off bleed (not bleed) position. A high pressure air supply is engaged fill port 20 and turned on. Adjusting handle 102 rotated counterclockwise will increase pressure and clockwise would decrease pressure in regulated chamber 12a as seen on gauge 117.

After desired pressure setting is obtained by reading gauge 117 (for example, 850 psi), turn off air supply and bleed unit. After the bleed nut is turned on and then off, typically the adjusted pressure will come back, but sometimes not all the way to the pre-bleed set pressure (example, 850 psi). Thus, the bleed nut will then be rotated to the not bleed position, the gas fill port reintroduced, and a second or final adjustment will be made. Following the second or final adjustment, the fill port is shut off, tool is bled, and bleed set pressure is again bled from the head, if necessary. Typically, several bleed/adjustment cycles will bring the gauge to the desired output pressure (for example, 850 psi). Adjuster head 112 may be removed and rotatable thread 103 may be rotated (without rotating handle 102 and therefore changing the pressure setting) to remove adjusting screw and adjuster head 112 from regulator 10. It is then set and ready to be installed on a PBG or other device.

It is noted that typical paint ball gun regulators are adapted to receive air supply gun cylinders 26 charged to either 3000 or 4500 psi. They are filled through fill port 20. When the regulator is adjusted as set forth in the paragraphs above, it is typical to use a fill port pressure of at least the pressure of the air supply gun cylinder 26. That is to say, when adjusting the regulator, a high pressure air supply is used, which is the same high pressure air supply that may be used for recharging air cylinder 26.

Set forth below are further details of the novel bayonet engagement structure between regulator cap 12 and regulator body 14.

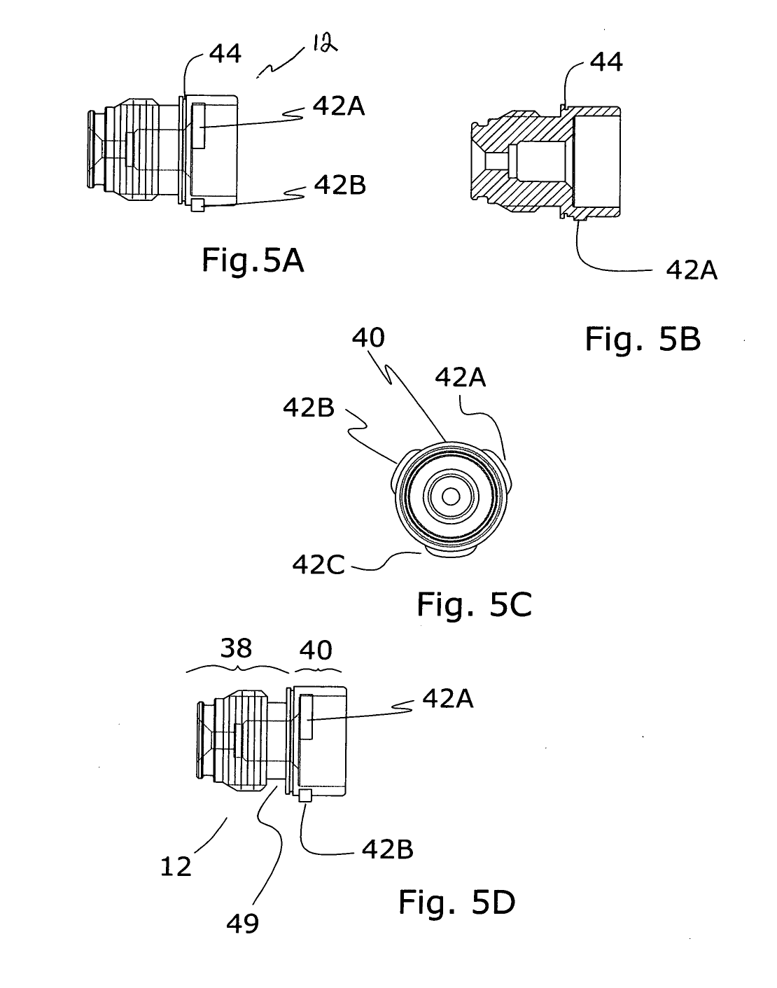

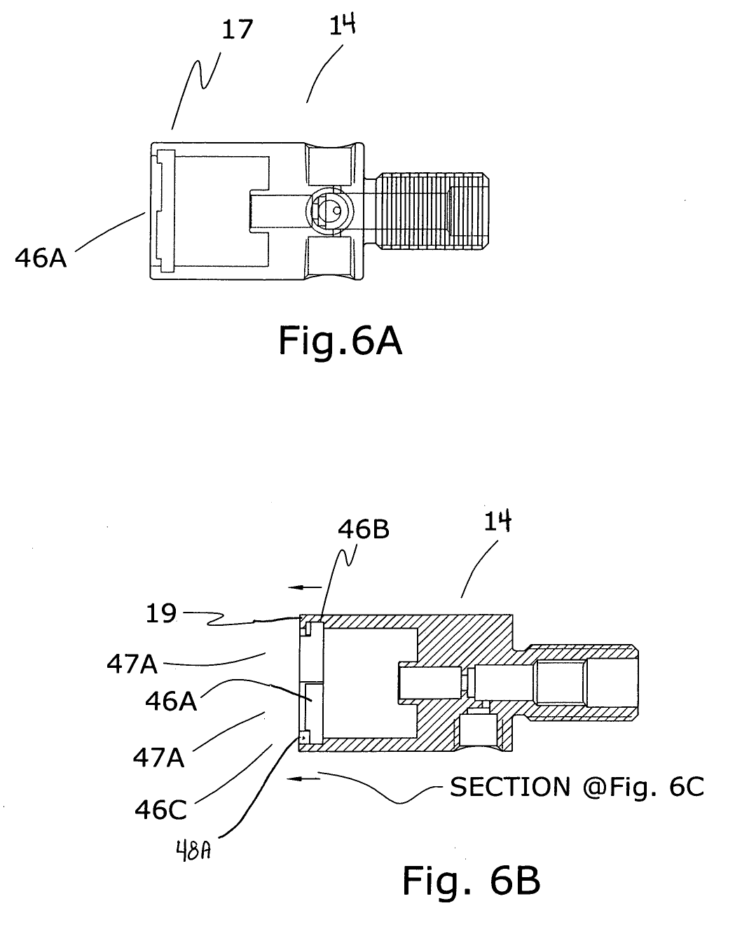

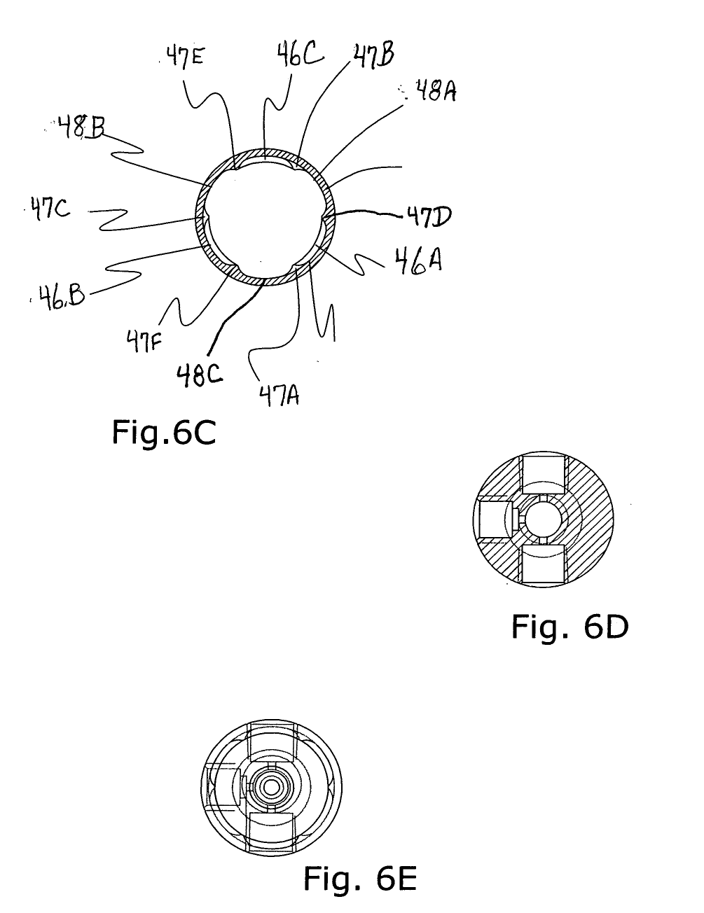

Turn now to FIGS. 5A-5D and 6A-6F, typical prior art regulator caps are threadably engaged to regulator bodies. As stated above, this sometimes creates problems. Applicants have provided a novel non-threaded engagement structure for attaching the regulator cap to the regulator body comprising a multiplicity of bayonets, here, bayonets or bosses 42a, 42b, and 42c, on regulator cap lower walls 40 (see FIG. 5D). Regulator cap lower walls 40 are insertable into the interior of the upper walls 17 of the regulator body 14.

Cutouts 48a, 48b, and 48c around the upper rim of the regulator body 14 allow space for bayonets 42a, 42b and 42c of the regulator cap to pass into the regulator body. Pockets 46a, 46b, and 46c are located on near end 14b of regulator body 14, spaced apart. They will accept the bayonets, and when engaged therewith will prevent the bayonets from rotating and will lock the cap to body so they two cannot separate. To engage, first the cap and body are pushed together. The bayonets pass the cutouts and, longitudinally, pass the pockets 46a, 46b, and 46c, spaced radially around the upper walls 17 of the regulator body 14. Then the body is rotated about 60° with respect to the cap. This aligns the bayonets below the cutouts. This is all done under compression. Compression is then released slowly and the bayonets are allowed to seat into the pockets, held there under pressure from the piston spring. (FIG. 2 shows a bayonet seated in a pocket.)

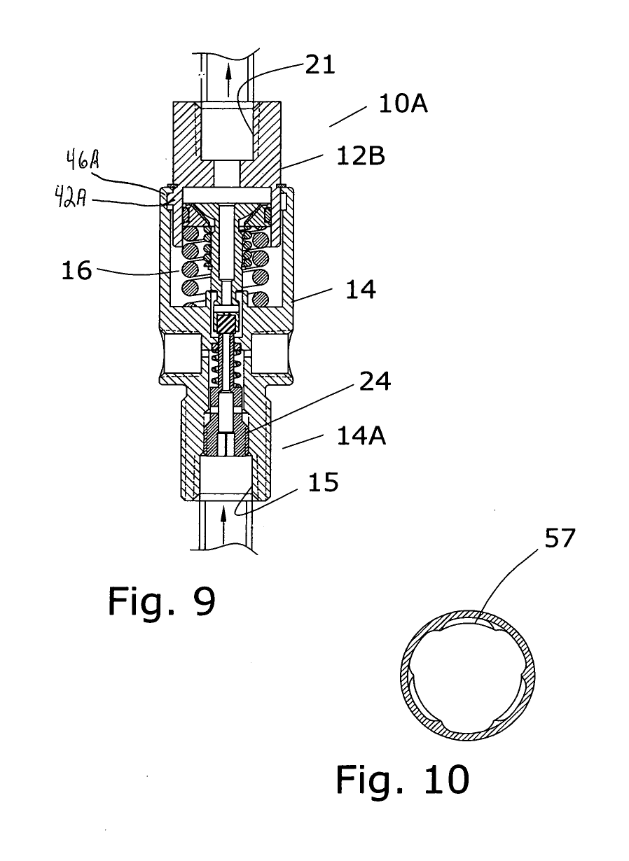

Pockets have an upside down “J” shape (FIG. 6C and FIG. 10) or an upside down “U” shape (FIG. 7). “J” shaped pocket has a set of short legs 47A, 47B, 47C, and a set of long legs (to act as “stop” when rotating bayonets) 47D, 47E, 47F (see FIG. 6C). “U” shaped pockets would have the same length legs. Gas pressure and/or piston spring force will urge the piston cap upwards securing the bayonets into the pockets. So pressed into the pockets, the bayonets are enclosed laterally by the pockets. The “J” shaped pocket 57 may be used to provide a positive stop (bayonet against wall of pocket) at 60° (see FIG. 10).

FIG. 6F illustrates a cross-sectional elevational view of the gas pressure regulator housing with the cap partially inserted into the regulator body illustrating the manner in which walls of the cap strike the piston head and spring before the bayonets of the cap have cleared the pockets, thus requiring the kit for compressing the body and the cap further before rotation and engagement of the cap bayonet to the body pockets. Of course, when the pockets are engaged with bayonets, the two parts cannot rotate. The bayonets are held tightly in the pockets by piston spring 18 or, when the regulator is in use, by the gas pressure in regulated chamber 124.

In FIG. 2, it is seen that a retainer clip 36 is provided to engage retainer clip groove 44, such that once the cap is inserted into the body, rotated, forced upward and locked, with the bayonets engaged in the pockets, then retainer clip groove 44, which is dimensioned to lie just above upper lip 19 of regulator body 14, will receive the retainer clip 36 which will be held snugly under compression in place in groove 44. The use of retainer clip 36 in retainer groove 44, when placed just above lip 19, will positively, securely maintain the cap longitudinally with respect to the body and prevent inadvertent compression and rotation (and thus release) of the regulator cap from the body. It is “back up” to the compression “lock” of the bayonets into the pockets.

With further reference to FIG. 6F, it can be seen that a series of O-rings, in conjunction with other structure, remove the necessity for a gas tight seal between the cap and the body. O-ring 60 is seen to engage regulator body 14 and adjustable seat neck 24e at a point upstream of seat 24c and downstream of the high pressure gas cylinder, the fill port and the regulated gauge 22. This O-ring will isolate the high pressure except as it is presented at seat 24c.

O-ring 62 is located between the piston stem and the cylinder body upstream of the channel end that terminates adjacent seat port 24c and soft seat or piston seat seal 34. This will allow the gas presented at the hard, replaceable seat port 24c (replaceable since it is an integral part of the adjuster screw) to move through seat seal 34 (the soft seat, replaceable at the end of the piston stem). This will allow the gas presented at seat port 24c to move through piston stem and into the regulated chamber 12a, but will not allow it to get to the spring chamber, between the cap 12 and the body 14. Moreover, gas flowing into the regulated chamber 12a will be constrained by O-ring 66. The effect of using these O-rings in conjunction with the cap and body allows for bayonet locking under pressure. The separation the O-rings provides at the high pressure end and the regulated chamber, sealing the regulated chamber from the chamber defined by the coupling of the body to the cap, that is, the chamber that contains spring 18.

It can be seen that all of the parts of Applicants' novel regulator are replaceable, due in part to the unique coupling and un-coupling. The soft seat, also called the pressure regulating piston seat seal 34, is replaceable, as are the O-rings. The bleed down piston is replaceable in ways known in the trade. The spring is replaceable as is the adjustable seat 24. There is no “throwaway” regulator just because one part is worn. If the cap is worn, a new cap can be used in conjunction with the old body piston and adjustable seat. Likewise, if the adjustable seat is worn or damaged, a new one may be provided, etc.

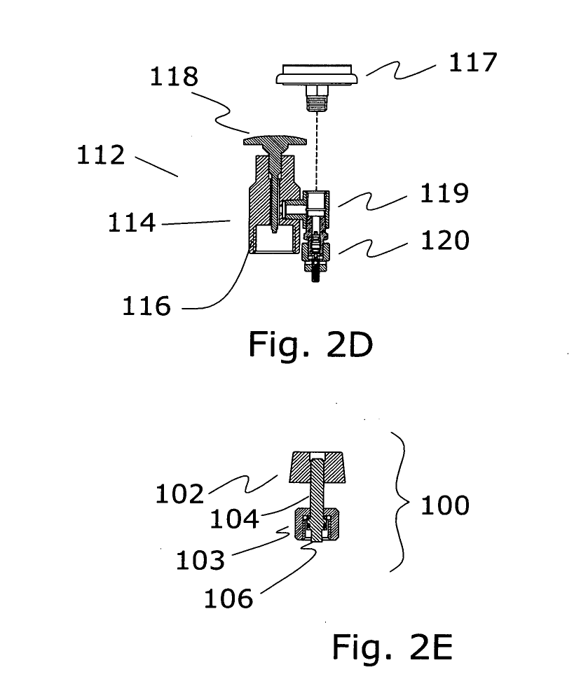

Turning to FIG. 3, it is seen that a novel clamp 50, having a clamp head 52, a clamp body 54, and a clamp threaded member 56, may be used to assist in placement on and removal of the cap from the body. As can be seen in FIG. 3, clamp head 52 is dimensioned to engage the cap while threaded member 56 is used to engage removed end 14a of regulator body 14. By threadably engaging the body at removed end 14a, rotation of threaded member 56 will allow compression of cap 12 into the body. Prior to this compression, the retaining ring must be removed. Compression of cap 12 into the body by rotating threaded member 56 will allow the bayonets to disengage from the pockets. Following such disengagement further rotation of the cap here, about 60 degrees along with the reversing of threaded member 56, will allow the cap, under tension, to be removed longitudinally from the body. The process is reversed for inserting the cap under compression into the body.

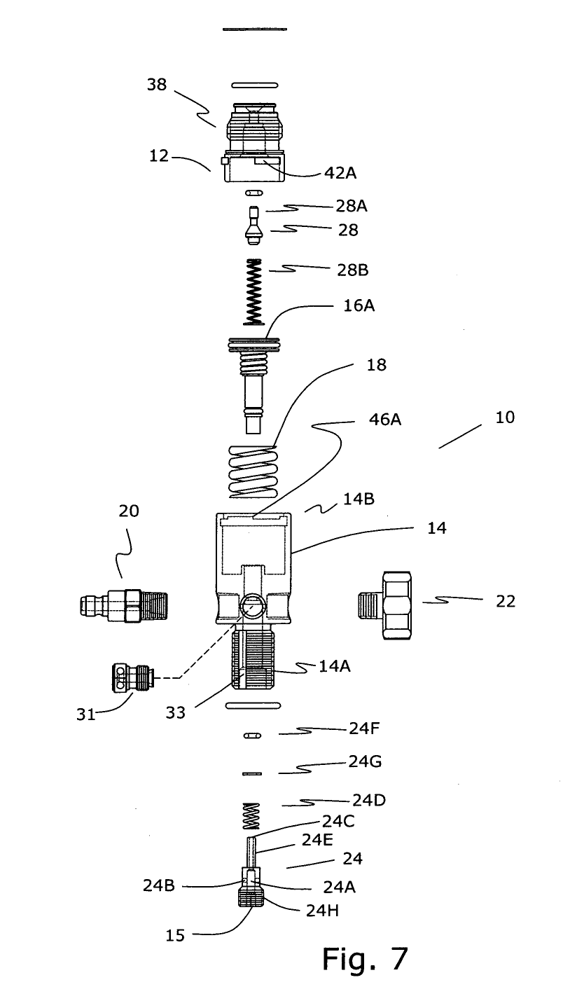

It may be appreciated with reference to regulator cap 12 and regulator body 14, as well as with respect to spring 18, that dimensions may be provided for the novel bayonet coupling means, comprising the cutouts and the bayonets, such that spring 18 will normally, in an unpressurized situation, be urging the body and the cap apart. That is to say, dimensions may be readily discernible with respect to the assembly set forth herein for providing the requirement that piston spring 18 be depressed slightly so as to urge the bayonets into the pockets under the urging of the spring 18. This can be seen in FIG. 6F. FIG. 6F shows the engagement of the top of the piston and the bottom of the piston spring and the walls of the cap striking the top of the piston. When this occurs, the cap and body are engaged, partially, but the bayonets have not gone far enough to clear the pockets and compression of the spring is required. When spring 18 is compressed enough so that the bayonets clear the pockets, cap tool 203 may be engaged with the cap to rotate it, typically about 60° and then the hex screw 204 may be backed out (FIG. 8B) to allow the bayonets to seat in the pockets. Moreover, spring 18 may be rather stiff and thus the proper engagement and disengagement of the cap with respect to the body will require some form of tool. That is to say, when regulator 10 is assembled and ready for use (unpressurized), there typically would be significant pressure locking the bayonets in their respective pockets. Therefore, a novel clamp is provided that may assist in the removal of the cap from the body as by, for example, providing alignment of the bayonets to the cutouts and the release of pressure so as to provide separation of the body from the cap and disassembly of the contents (piston, springs, adjuster screw, etc.).

FIGS. 8A, 8B, and 8C provide a preferred embodiment of a disassembly/assembly means (compare to FIG. 3), including a clamp 200 having a hex screw 204, a hex tool 201, as well as a cap wrench or tool 203. When one requires removal of cap 12 from body 14, housing 13 is placed in clamp 200 with threaded hex screw 204 engaging cap 12 as seen in FIG. 8B. Fixed boss 206 engages removed end 14A of regulator body 14 as seen in FIG. 8B. Rotation of hex screw 204, using hex tool 201 will allow compression and decompression of cap 12 from the body 14.

Turning now to FIG. 8A, it is seen that to assembled regulator housing 13, cap 12 is placed against body 14 and snugly received therein until there is interference with piston and piston spring as set forth above. Bayonets (42a and 42b as shown in FIG. 8A) will be aligned with cutouts and the housing 13 can then be placed in the clamp 200 for compression of the cap into the body (again, carefully with the bayonets and cutouts aligned). Compress the housing by turning hex tool 201. Wrench or cap tool 203 engaging flats 49 on cap 12 (see also FIGS. 5D and 8C) will allow rotation of the cap about 60° so as to align the bayonets with the pockets. When the bayonets are aligned with the pockets and hex screw 204 backed out, spring 18 will urge the cutouts opening to the pockets as seen in FIG. 2. For proper engagement, retainer clip groove 44 must “show” above the upper edge of the cap so that retainer clip 36 can be engaged.

For removal of cap 12 from body 14, one would reverse the procedures set forth above, with retainer clip 36 removed first. After retainer clip 36 is removed, the housing 13 is compressed until the bayonets clear the pockets, and the user can “feel” the bayonets bottom out. Then wrench or cap tool 203 can rotate the cap with respect to the body, about 60°, and compression released. Caution must be taken not to over-compress (damaging the bayonets) during assembly one ought to compress until the cap movement stops and then back off slightly.

The disclosure of Applicant's novel features, alone and in combination herein, are applied, for any air pressure regulation need and, in some embodiments, the needs and requirements of a paintball gun. However, the novel features of Applicant's embodiments set forth herein are applicable to other gas pressure regulator needs. The novel bayonet engagement means between the cap and body may be used in regulators that have uses outside the paintball industry. Likewise, the novel pressure adjusting features and the novel kit for assembly and disassembly of the regulator housing likewise may be used outside of the paintball industry.

While the engagement means set forth herein illustrate a regulator cap having a bayonet and the regulator housing having pockets dimensioned for receipt of the bayonets therein, bayonet engagement is to be understood to include an embodiment having bayonets on the regulator body and pockets on the cap. Moreover, while three bayonet/pocket combinations are illustrated, one or more may be used. Moreover, the pockets and bayonets would be distributed about the inner walls with equal spacing, one from the other. That is to say, if two bayonet/pocket combinations were used, they would preferably set at 180° angle, one with respect to the other. The three set combinations disclosed herein are set at 120° with respect to one another. Four would be set at 90° with respect to one another, etc.

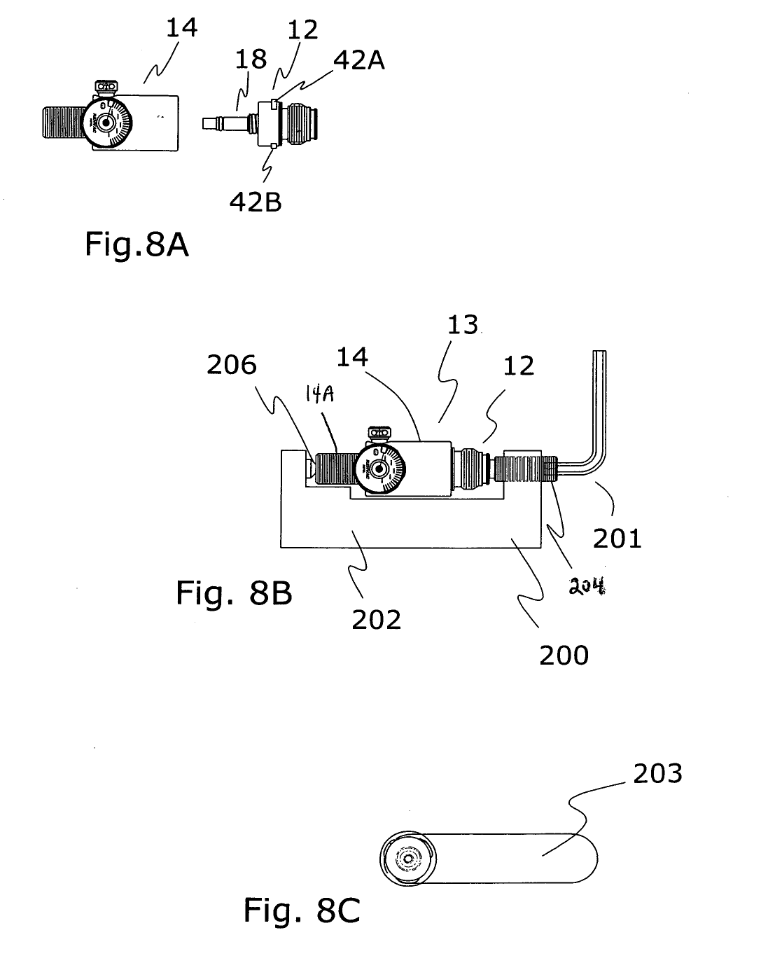

FIG. 9 illustrates a cross-sectional view of an alternate preferred embodiment of Applicants' present invention. More specifically, FIG. 9 illustrates an embodiment of Applicants' present invention that can be used as an in-line regulator, controlling gas pressure regulator between a high pressure inlet line and a regulated pressure output line.

FIG. 9 illustrates an alternate preferred embodiment of Applicants' device. More specifically, FIG. 9 illustrates an in-line gas pressure regulator 10a that is adapted from the previous embodiments set forth herein. The adaption generally provides for threaded engagement of the regulator body 14 at an upstream end thereof with a fitting on an upstream high pressure line. This is typically achieved through threading the moved end 14A of body 14 internally with threaded portion 15 as indicated in FIG. 9. Further, regulator cap 12b in an alternative embodiment has threaded portion 21 for threadable engagement with a fitting on downstream line carrying regulated pressure. Other elements of Applicants' alternate preferred embodiment are essentially and generally the same as the embodiments set forth above.

Adjusting screw tool 100 (see FIG. 2A) may be used for the alternate preferred embodiment of FIG. 9 with threads on the outside of removed end 14A of body 14 with which to couple rotatable threaded member 103. Otherwise, rotatable threaded member 103 may be modified to engage threaded inner walls 15. Further, adjuster head 112 may be modified so that threaded portion 116 is a male portion to fit the female portion 21 in FIG. 9. Moreover, depressor 118 is not needed.

Apparent from the above specification is that Applicants' novel bayonet engagement, while typically requiring a clamp device to engage and disengage (unless the spring has a light pressure), provides for a number of advantages, including the ability to form positive engagement that is not likely to threadly screw loose or otherwise disengage. Further, the bayonet engagement is a coupling of a body to a cap, which coupling itself does not require a gaseous tight engagement. That is to say, it is the O-ring on the piston head that provides a gas pressure sealant to the regulated pressure and the O-ring against the adjuster seat which provides gas fluid sealing to the upstream or high pressure gas cylinder. The chamber that exists between the regulated and high pressure side may be ambient.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A kit for use with the regulation of gas pressure, the kit comprising:
a gas pressure regulator, the gas pressure regulator including a housing having a longitudinal axis, the housing comprising a regulator cap including walls defining an outlet port and a regulator body having walls defining a spring chamber, the cap and body engaging one another through the use of coupling bayonets and pockets, the regulator further comprising a piston spring and a piston having a piston head, the piston spring and piston for engaging the cap and the regulator body, the regulator cap further including walls capable of receiving the piston head;
a clamp with a clamp body, the clamp with a member adapted to engage one of the regulator body or the regulator cap and an adjustable member capable of engaging the other of the regulator body or regulator cap to compress the piston against the piston spring and to urge the regulator body toward the regulator cap so as to assist in the assembly and disassembly of the regulator body from the regulator cap.

2. The kit of claim 1, wherein the adjustable member is threadably engaged with the clamp body.

3. The kit of claim 2, further including a cap tool to engage the cap when the regulator is engaged with the clamp.

4. A regulator assembly for use with a pressurized gas source, the regulator assembly comprising:
a gas pressure regulator including a housing having a fill port, the housing comprising a regulator cap and a regulator body, the cap and body capable of bayonet engagement, the cap including a threaded removed end and the body including a threaded removed end, the gas pressure regulator including a piston and a piston spring, the piston having a piston seat at a removed end thereof, the gas pressure regulator having an adjustable seat threadably engaging the regulator body and having a port opening dimensioned and adapted to be adjustably set with respect to the piston seat; and
a gas pressure regulator adjuster kit, including an adjusting screw tool capable of engaging the threaded end of the body and the adjustable seat; and
an adjuster head capable of threadable gas tight receipt onto the threaded portion of the regulator cap;
wherein the regulator is pressurized through the fill port and the regulated pressure of the regulator is set through engagement of the adjusting screw tool with the adjustable seat of the regulator; and
the adjuster head having a gas pressure gauge coupled therewith for reading an adjusted gas pressure of the regulator.

5. The regulator of claim 4, wherein the adjuster head includes a bleed nut.

6. The regulator of claim 4, wherein the cap includes an outlet valve piston and the adjuster head includes a member for engagement with the outlet valve piston.

7. A kit for use with the regulation of air pressure, the kit comprising:
a gas pressure regulator, the gas pressure regulator including a piston having a piston head, a housing having a longitudinal axis, the housing comprised of a regulator cap, the regulator cap further including walls capable of receiving a piston head, including walls defining an outlet port and a regulator body having walls defining a spring chamber, and a near end and a removed end, the removed end adapted to engage a compressed gas cylinder, the cap and body engaging one another through the use of bayonets and pockets, the regulator further comprising a piston and a piston spring, the piston having a piston head and having a piston stem with a channel therethrough, the channel opening to the piston head, the channel having seat seal at a removed end thereof, the piston spring and piston engaging the cap and the regulator body.

8. The kit of claim 7, wherein the regulator body is adapted to compress the piston spring when the cap and body are engaged, and the bayonets are seated in the pockets.

9. The kit of claim 7, wherein the cap includes a regulated chamber, in gaseous communication with the outlet port and the regulator includes an outlet valve movably cooperating with the outlet port, to control gas movement from the regulated chamber.

10. The kit of claim 9, further including an adjustable seat for engagement with the removed end of the body, the adjustable seat having a channel therethrough, with a first end in gaseous communication with the compressed gas cylinder and a second end defining a seat port, the adjustable seat capable of being adjustably positioned with respect to the piston seat seal thereupon.

11. The kit of claim 9, wherein the adjustable seat includes walls defining a tool engagement opening at the first end thereof, and wherein the adjustable seat and the body are adapted for threadable coupling, and wherein rotation of the threadable coupling moves the adjustable seat.

12. The kit of claim 11, further including a tool for engagement with the tool engagement opening of the adjustable seat.

13. The kit of claim 7, further including a clamp adapted to compress the body with respect to the cap in order to assemble and disassemble the regulator.

14. A method for adjusting the output pressure of a regulator, the regulator comprising:
a regulator, the gas pressure regulator including a housing having a longitudinal axis, the housing comprised of a regulator cap including walls defining an outlet port and a regulator body having walls defining a spring chamber, and a near end and a removed end, the removed end adapted to engage compressed gas cylinder, the cap and body engaging one another through the use of bayonets and pockets, the regulator further comprising a piston spring and a piston, the piston head having a piston stem with a channel therethrough, the channel opening to the piston head, the piston stem having seat seal at a removed end thereof, the piston spring and piston for engaging the cap and the regulator body, the regulator cap further including walls capable of receiving the piston head;
wherein the cap includes a regulated chamber, in gaseous communication with the outlet port and the regulator includes an outlet valve movably cooperating with the outlet port, to control gas movement from the regulated chamber; and
further including an adjustable seat for engagement with the removed end of the body, the adjustable seat having a channel therethrough, with a first end in gaseous communication with the compressed gas cylinder and a second end defining a seat port, the adjustable seat capable of being adjustably positioned with respect to the piston seat seal thereupon;
the steps including;
providing a tool for engagement with the tool engagement opening of the adjustable seat;
providing an adjustable head adapted to engage in a gaseous tight manner, the regulator cap when it is coupled to the body, the adjuster head having a body with a port at a near end and a compressor coupled to the body, dimensioned to engage the outlet valve of the cap when the adjuster head is engaged with the cap, the body having an inner volume, with the gas pressure gauge coupled therewith;
engaging the adjuster head to the cap;
engaging the fill port of the body to a high pressure source;
engaging the engagement tool to the engagement opening;
adjusting the adjuster screw until the desired pressure, on the gauge of the adjuster head reaches the desired output pressure; and
uncoupling the adjuster head from the regulator.
